(19) United States
(12) Patent Application Publication
(10) Pub. No.: US 2009/0001689 A1
(43) Pub. Date: Jan. 1, 2009

(54) WHEEL CHAIR HANDLE

(76) Inventor: Everett E. Swenson, Paxton, IL (US)

Correspondence Address: COOK ALEX LTD, SUITE 2850, 200 WEST ADAMS STREET, CHICAGO, IL, 60606, US

(21) Appl. No.: 12/146,585

(22) Filed: Jun. 26, 2008

Related U.S. Application Data
(60) Provisional application No. 60/946,530, filed on Jun. 27, 2007.

(51) Int. Cl. A61G 5/10

(52) U.S. Cl. 280/304.1

(57) ABSTRACT

A removable handle assembly for use with a wheel chair includes a pair of elongate tubular members each having a longitudinally extending passage therein extending along the elongate axis of the tubular member. A first end of each of the tubular members is movable relative to each other to permit adjustment of the tubular members relative to each other along their elongate axes. A mount is positioned adjacent a second end of each of the elongate tubular members opposite the first end. Each mount has an open face thereon configured to receive, engage and grip one side of the tubular rearwardly extending handles of the wheel chair when positioned into engagement therewith. A stretchable flexible cord is also positioned adjacent each mount and the ends of each cord are attached to the second ends of each of the tubular members. Each said cord is stretchable so as to be positioned in gripping relationship to the side of the tubular handles of the wheel chair opposite the mounts to firmly mount the handle assembly to the wheel chair handles in substantially horizontal lateral relationship to the wheel chair.

### RELATED APPLICATION

This application is a nonprovisional application which claims the benefit of prior filed U.S. provisional application Ser. No. 60/946,530, filed Jun. 27, 2007 which is incorporated by reference herein in its entirety.

### BACKGROUND AND SUMMARY OF THE INVENTION

The present invention is directed to a wheel chair handle assembly for mounting onto a conventional wheel chair.

Many people who are confined to a wheel chair are unable to move the wheel chair themselves and require assistance to do so by a care giver, such as aides, spouses, relatives or other residents living in a shared facility. Moreover, in may cases the care giver is not in much better condition than the patient in the wheel chair. Also, it is not uncommon for the care giver, such as a therapist, to walk the patient while holding onto and guiding the patient with one hand and pulling the empty wheel chair with the other hand in the event that it is needed.

Handle assemblies have been available in the past for attachment to and removal from the rearwardly extending wheel chair handles which conventionally exist on wheel chairs in order to provide a horizontal, laterally extending push handle across the back of the wheel chair. Such laterally extending handles do facilitate manipulation of the wheel chair by the care giver and can free one hand of the pusher for other uses. However, the prior horizontal laterally extending handle assemblies have suffered from one or more of a number of disadvantages including:
complexity and/or difficulty to install the handle assembly on or remove it from the wheel chair.
installations or components which are not firm, sturdy and/or reliable.
the need for tools to install or remove the handle assembly from the wheel chair.
complexity of construction or assembly of the handle assembly.
the need to remove the handle bar grips from the pre-existing handles of the wheel chair in order to install the handle assembly on the handle bars of the wheel chair.
multiple parts or components of the handle assembly which might become separated from the assembly during attachment or removal and become lost.

The handle assembly of the present invention overcomes most, if not all, such disadvantages.

The handle assembly of the present invention is simple and easy to quickly install on and/or remove from the wheel chair, the latter for example when it is desired to collapse the wheel chair, store the assembly or use the handle assembly on a different wheel chair. The installation and components of the handle assembly of the present invention are firm, sturdy and reliable, and the assembly may be installed and removed without the need for tools. The manner of installing, using and removing the handle assembly of the present invention is simple and readily understood by persons having little training, and there is no need to remove the handle bar grips from the handles of the wheel chair in order to install the handle assembly of the invention. In addition, there are no component parts of the handle assembly of the present invention which might or need be separated from the assembly during installation, removal or storage of the assembly, and thus might be subject to loss. And, when two of the handle assemblies of the invention are installed on two different wheel chairs, one person is able to push both wheel chairs at the same time with greater ease. This may be particularly beneficial in the transport of two wheel chair patients at the same time to attend communal nursing home activities, such as meals, or to transport multiple empty wheel chairs from one place to another at the same time.

These and other objects, features and advantages of the present invention will be more clearly understood through a consideration of the following detailed description.

### BRIEF DESCRIPTION OF THE DRAWINGS

In the course of this description, reference will frequently be made to the attached drawings in which:

FIG. 1 is a partially broken perspective view of a wheel chair with the handle assembly of the present invention positioned in readiness for installation on the wheel chair;

FIG. 2 is a partially broken rear elevation view of the handle assembly as substantially shown in FIG. 1 which has been positioned on the rearwardly extending handle bars of the wheel chair;

FIG. 3 is an exploded view of the handle assembly of the invention as substantially shown in FIG. 2 and showing the components thereof and

FIG. 4 is a cross sectioned elevation view of the handle assembly as substantially shown in FIG. 2.

### DETAILED DESCRIPTION OF THE PREFERRED EMBODIMENT

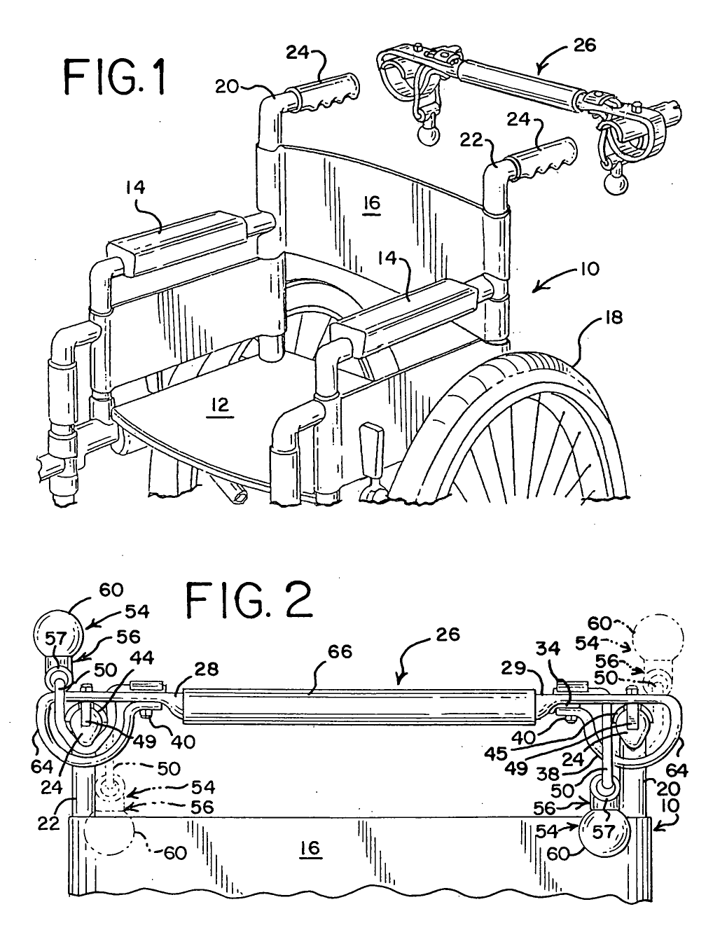

Referring to FIGS. 1 and 2, a conventional wheel chair 10 is shown having a seat 12 and arms 14 and back 16 for comfortably receiving the patient to be seated and wheeled in the chair. The wheel chair 10 also conventionally includes wheels 18 and handle bars 20 and 22 which extend horizontally toward the rear of the wheel chair for the use of a care giver in pushing the chair. Each of the handle bars 20 and 22 typically also includes handle bar grips 24 which facilitate gripping of the handle bars by the care giver who is pushing the wheel chair. Also as is typical in wheel chairs, the seat 12 and back 16 may be formed of a flexible material which permits the wheel chair 10 to be collapsed for storage or transport when the patient is not seated in the wheel chair.

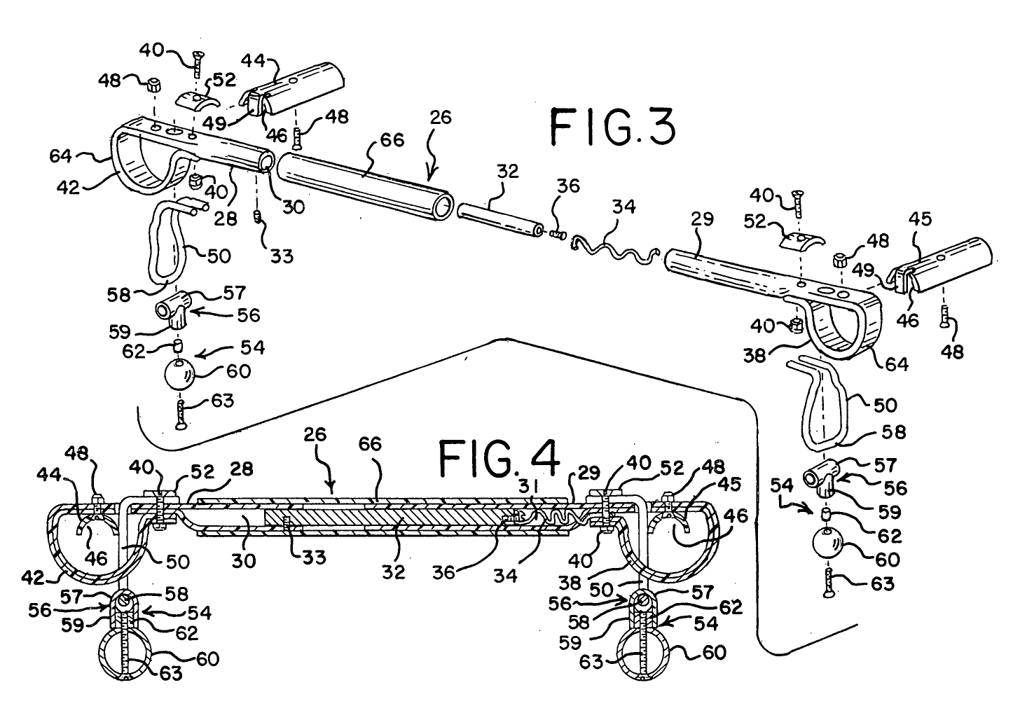

The handle assembly of the invention may be installed on or removed from such conventional wheel chairs. The preferred handle assembly 26 of the invention includes a pair of elongate tubular members 28 and 29 each of which has a longitudinally extending passage 30 and 31 respectively therein as best seen in FIGS. 3 and 4.

An elongate element of reduced diameter, such as a rod 32, extends from the ends of the tubular members 28 and 29 which are proximate to each other and into at least one and preferably both of the respective passages 30 and 31 as best seen in FIG. 4. The rod 32 is preferably fixed adjacent one of its ends to the tubular member 28. As shown in the drawing, one end of the rod 32 extends into the passage 30 and is fixed by a screw 33 so as to be immobile relative to tubular member 28 and its passage 30. The other end of the rod 32 which extends into the passage 31 of tubular member 29 is slidably movable in the passage 31 so that the tubular member 29 is movable relative to the rod 32 along the longitudinal axis of the tubular members. This permits the overall length of the tubular members along their axes to be adjustable relative to each other to compensate for and accommodate differing distances between the handle bar grips 24 on different wheel chairs. Because tubular member 29 is mobile for adjustment in relation to tubular member 28, tubular member 29 is preferably of a longer length than tubular member 28 to accommodate such adjustments.

Although tubular member 29 may be moved along its longitudinal axis relative to tubular member 28 in the handle assembly of the invention, such movement is preferably limited so as to prevent tubular member 29 from becoming separated from the rod 32. The limitation of such movement may be provided for example by a flexible member or cord 34 which may be attached at one end by a screw 36 to the rod 32 and at the other end may be clamped between elements of a strengthening assembly 38 by a nut and bolt 40. The strengthening assembly 38 and its corresponding strengthening assembly 42 at the other end of the handle assembly will be discussed later in the description of the preferred embodiment.

It will be understood that although “screws”, “bolts” and “nuts” have been referred to throughout this specification as fastening members, other forms of fastening for example adhesives, welding, fusing, molding together, etc. may be employed by those skilled in the art without departing from the invention.

The handle assembly 26 also preferably includes mounts 44 and 45 at the outer end of each of the tubular members 28 and 29, respectively. The mounts 44 and 45 may be formed of a somewhat elongated cylindrical tube which has been sectioned over its length so as to present a more or less semicircular cross section with a downwardly facing open face 46 over their length which is capable of engaging and firmly gripping the top side of the handle bar grips 24 of the wheel chair when the handle assembly is installed on the wheel chair. Although the mounts 44 and 45 have been shown as generally semicircular in cross section, it will be appreciated that they may have different cross sections, such as V-shaped or the like. Such different shapes may actually improve the gripping function of the mounts with the handle bar grips 24. In addition, the underlying surface of the mounts which engages the top side of the handle bar grips 24 may be formed with ribs or the like (not shown) to further facilitate gripping of the handle bar grips 24.

The mounts 44 and/or 45 also preferably include a downwardly extending projection 49 at the end of the mounts which face away from the wheel chair, as best seen in FIGS. 2 and 3. The projections 49 act to limit the movement of the handle assembly 26 toward the wheel chair when it is being installed or when it is being pushed by the care giver.

Although the mounts 44 and 45 are shown as fixed to the underside of the strengthening assemblies 38 and 42 with nuts and bolts 48, it will be appreciated that other forms of fastening may be employed as previously mentioned.

To accomplish the final installation to and/or removal from of the handle assembly 26 in relation to the handle bar grips 24 of the wheel chair, a stretchable flexible cord 50 is formed into a loop and the ends of the cord are clamped at the outer ends of the tubular members 28 and 29 beneath a clamp plate 52 with bolts 40.

A handle 54 of some form is also preferably provided on the cord 50 to facilitate moving it between its positions to install and remove the handle assembly 26 to and from the wheel chair 10 and its handle bar grips 24. As shown in FIGS. 3 and 4, the handle 54 preferably includes a T-shaped tubular member 56 having a horizontal portion 57 through which the bight 58 of the looped cord 50 loosely passes, and a vertical portion 59 which extends perpendicular to the horizontal portion 57. A shape which facilitates manual grasping by the user is preferably provided on the T-shaped tubular member 56 which shape may take the form of a ball 60 which is attached to the vertical portion 59 for example by a plug 62 and screw 63 as best seen in FIGS. 3 and 4.

As previously mentioned, strengthening assemblies 38 and 42 are preferably provided at the outer ends of tubular members 29 and 28, respectively. As shown in the drawings, the strengthening assemblies 38 and 42 may be formed in one piece relationship with the tubular members simply by flattening the tubular members 28 and 29, shaping the flattened portion generally into a loop 64, and bolting the furthest end of the loop to the assembly with nuts and bolts 40. The strengthening assemblies 38 and 42 act to strengthen the handle assembly 26 and its tubular members 28 and 29 during manipulation of the flexible stretchable cords 50 during the installation and removal of the handle assembly 26 to or from the grips 24 of the wheel chair, and they also improve the gripping function of the cords 50 when the handle assembly 26 is installed on the wheel chair. They also act as an anchor for the cords when the handle assembly is on the wheel chair.

Finally, a tubular cover 66 is preferably installed over the tubular members 28 and 29 and rod 32. The tubular cover 66 preferably takes the form of a softer material, such as rubber or a suitable plastic, which improves the grip by the pusher of the wheel chair and is more comfortable on the hands.

From the foregoing description of the handle assembly 26, it is believed that the installation on and/or removal from the wheel chair 10 will be evident. However, a brief description thereof follows.

To prepare the handle assembly 26 to be received on the grips 24 of the wheel chair 10, the length of the handle is adjusted over its longitudinal axis so that the mounts 44 and 45 are spaced from each other by the same distance as the distance between the handles 20 and 22 on the wheel chair 10 and their grips 24. This is simply accomplished by moving the tubular member 28 along rod 32.

Once the mounts 44 and 45 have been adjusted, they are slipped onto the grips 24 so that open face 46 rests on the tops of the grips. When they are properly positioned on the grips 24, further motion of the handle assembly 26 toward the wheel chair is limited by the projections 49 on the mounts 44 and 45. At this point, the flexible stretchable cords 50 and their handles 54 which have been hanging downwardly as seen in FIG. 4 are stretched and brought up and over the top of the loop of the respective strengthening assemblies 38 and 42 as seen in FIG. 2. This will draw tension on the cords 50 and cause them to grip the underside of the handle bar grips 24 of the wheel chair as seen in FIG. 2, and also increase the grip of the mounts 44 and 45 on the topside of the handle bar grips 24.

To remove the handle assembly 26 from the wheel chair, for example when it is desired to collapse or store the wheel chair or to use the assembly on another wheel chair, all that need be done is to stretch the cords 50 and return the cords and their handles 54 to the hanging position shown in FIG. 4. The mounts 44 and 45 may then be simply slid off the handle bar grips 24 and away from the wheel chair.

From the foregoing, it will be appreciated that the handle assembly of the present invention is simple and easy to quickly install on or remove from the wheel chair, and its installation and components are firm, sturdy and reliable. Moreover, there is no need for tools to install or remove the handle assembly to or from the wheel chair, and the assembly is simple in construction. It will also be appreciated that there is no need to remove the preexisting handle bar grips from the wheel chair to install or remove the handle assembly from the wheel chair, and that the handle assembly does not include any parts or components which might become separated from the assembly during installation, removal or storage of the assembly, and thereby be subject to loss.

It will also be understood that the preferred embodiment of the present invention which has been described is merely illustrative of the principles of the present invention. Numerous modifications may be made by those skilled in the art without departing from the true spirit and scope of the invention.

1. A removable handle assembly for use with a wheel chair, comprising:
a pair of elongate tubular members each having a longitudinally extending passage therein extending along the elongate axis of said tubular members, a first end of each of said tubular members being movable relative to each other to permit adjustment of said tubular members relative to each other along their elongate axes;
a mount adjacent a second end of each of said elongate tubular members opposite said first end, each said mount having an open face thereon configured to receive, engage and grip one side of the tubular rearwardly extending handles of the wheel chair when positioned into engagement therewith; and
a stretchable flexible cord adjacent each said mount, the ends of each said cord being attached to said second ends of each of said tubular members, and each said cord is stretchable so as to be positioned in gripping relationship to the side of the tubular handles of the wheel chair opposite said mounts to firmly mount the handle assembly to the wheel chair handles in substantially horizontal lateral relationship of the wheel chair.

2. The assembly of claim 1, wherein one of said tubular members includes an elongate reduced diameter element which extends from its said first end to said first end and into the passage of the other said tubular member to permit adjustment of said tubular members relative to each other along their elongate axis.

3. The assembly of claim 2, wherein said elongate reduced diameter element is an elongate rod.

4. The assembly of claim 3, wherein said elongate rod is fixed to one of said tubular members, but the other of said tubular members is movable relative to said rod.

5. The assembly of claim 4, wherein the tubular member which is movable relative to said rod is longer than the other tubular member.

6. The assembly of claim 4, wherein the extent of movement of the movable tubular member is limited in the direction away from the other tubular member.

7. The assembly of claim 6, wherein the extent of movement is limited by a flexible member fixed at one end to said rod and at its other end to said movable tubular member.

8. The assembly of claim 2, wherein said elongate tubular members and said reduced diameter element are covered by an elongate cover over a substantial portion of their length.

9. The assembly of claim 1, in which said mounts and their said open faces extend at a substantial angle to the elongate axes of said tubular members.

10. The assembly of claim 1, wherein said mounts and their said open faces are constructed and arranged to engage the top side of the rearwardly extending handles of the wheel chair, and the cords are constructed and arranged to grip the underside of the handles.

11. The assembly of claim 1, including a projection on said mounts to limit the movement of said mounts toward the wheel chair when the mounts are engaged with the handles of the wheel chair.

12. The assembly of claim 1, wherein each said stretchable flexible cord include a handle to facilitate grasping of the cords to move them into and out of gripping relationship to the handles of the wheel chair.

13. The assembly of claim 1, wherein each said stretchable flexible cord comprises a loop.

14. The assembly of claim 1, including a strengthening assembly adjacent said second end of each of said elongate tubular members to strengthen said tubular members during the positioning of said stretchable flexible cords.

15. The assembly of claim 14, wherein said strengthening assembly is generally in the shape of a loop.

16. The assembly of claim 14, wherein each said stretchable flexible cord engages said strengthening assemblies when the cords are in gripping relationship with the tubular handles of the wheel chair.

17. The assembly of claim 1, including an elongate rod which is fixed to one of said tubular members, but the other of said tubular members is movable relative to said rod and is longer than said one of said tubular members; a flexible member fixed at one end to said rod and its other end is fixed to said movable tubular member to limit the extent of movement of the movable tubular member in the direction away from the other tubular member; said elongate tubular members and said reduced diameter element being covered by an elongate cover over a substantial portion of their length; said mounts and their said open faces extend at a substantial angle to the elongate axes of said tubular member and are constructed and arranged to engage the top side of the rearwardly extending handles of the wheel chair; each said stretchable flexible cord is constructed and arranged to grip the underside of the wheel chair handles; a projection on said mounts limits the movement of said mounts toward the wheel chair when the mounts are engaged with the handles of the wheel chair; a handle on each said stretchable flexible cord to facilitate grasping of the cords to move them into and out of gripping relationship to the handles of the wheel chair; and wherein each said stretchable flexible cord comprises a loop.

18. The assembly of claim 17, including a strengthening assembly generally the shape of a loop adjacent said second end of each of said elongate tubular members to strengthen said tubular members during the positioning of said stretchable flexible cords; and wherein said stretchable flexible cords engage said strengthening assembly when the cords are in gripping relationship with the tubular handles of the wheel chair.

19. A removable handle assembly for use with a wheel chair, comprising:
a pair of elongate tubular members each having a longitudinally extending passage therein extending along the elongate axis of said tubular members, a first end of each of said tubular members being movable relative to each other to permit adjustment of said tubular members relative to each other along their elongate axes; and
a loop adjacent a second end of each of said elongate tubular members opposite said first end, said loop being configured to receive the tubular rearwardly extending handles of the wheel chair therein for engagement of the handles when the handles are positioned within the respective loops.

20. The assembly of claim 19, including an adjustment member associated with each said loop to change the degree by which the handles are gripped within said loops.

21. A removable handle assembly for use with a wheel chair, comprising:
a pair of elongate tubular members each having a longitudinally extending passage therein extending along the elongate axis of said tubular members, a first end of each of said tubular members being movable relative to each other to permit adjustment of said tubular members relative to each other along their elongate axes;
a gripping element adjacent a second end of each of said elongate tubular members opposite said first end, each said gripping element being configured to receive therein the tubular rearwardly extending handles of the wheel chair for engagement of the handles when the handles are positioned within the respective gripping elements; and
a flexible cord fixed between each of said tubular members and permitting movement of each of said tubular members relative to each other, but restraining movement of the tubular members away from each other.

22. The assembly of claim 21, wherein said flexible cord extends into the passage of at least one of said tubular members.

23. The assembly of claim 22, including an elongate reduced diameter element which his fixed within the passage of at least one of said tubular members, and wherein an end of said flexible cord is attached to said reduced diameter element.

24. The assembly of claim 23, wherein said flexible cord extends into the passage of at least one of said tubular members.

25. The assembly of claim 23, including an elongate cover which covers a substantial portion of said tubular members, reduced diameter element and flexible cord.

26. The assembly of claim 21, including an elongate cover which covers a substantial portion of said tubular members and said flexible cord.

27. The assembly of claim 21, wherein said gripping elements comprise a loop adjacent a second end of each of said elongate tubular members opposite said first end, said loop being configured to receive the tubular rearwardly extending handles of the wheel chair therein for engagement of the handles when the handles are positioned within the respective loops.

28. The assembly of claim 25, wherein said gripping elements comprise a loop adjacent a second end of each of said elongate tubular members opposite said first end, said loop being configured to receive the tubular rearwardly extending handles of the wheel chair therein for engagement of the handles when the handles are positioned within the respective loops.
